(19) United States
(12) Patent Application Publication
(10) Pub. No.: US 2012/0174296 A1
(43) Pub. Date: Jul. 12, 2012

(54) TWO-PIECE CHEMICAL AND/OR BIOLOGICAL PROTECTIVE GARMENT

(75) Inventor: Thomas S. Martin, Huber Heights, OH (US)

(73) Assignee: LION APPAREL, INC., Dayton, OH (US)

(21) Appl. No.: 13/313,704

(22) Filed: Dec. 7, 2011

Related U.S. Application Data
(60) Provisional application No. 61/420,458, filed on Dec. 7, 2010.

(51) Int. Cl. A62B 17/00

(52) U.S. Cl. 2/457

(57) ABSTRACT

Chemical and/or biochemical resistant protective garments are disclosed that include a top part having a body portion and sleeves, the body portion having a vapor skirt that is self-tightenable towards the torso of a wearer, and a bottom part having a fold-over waistband extension, a waistband, a seat portion, and left and right leg portions, the fold-over waistband extension being foldable over the waistband to reveal a backside of the fold-over waistband extension when the bottom part is worn by the wearer. When the top and bottom parts are worn by the wearer, the vapor skirt is positioned against the backside of the fold-over waistband and is self-tightened thereagainst as a seal that is generally impermeable to gases.

### CROSS REFERENCE TO RELATED U.S. PATENT APPLICATION

This application claims the benefit of U.S. Provisional Patent Application Ser. No. 61/420,458, filed Dec. 7, 2010, the complete disclosure of which is hereby incorporated by reference.

### BACKGROUND

Protective or hazardous duty garments are used in a variety of industries and settings to protect the wearer from adverse conditions such as heat, flames, smoke, cold, sharp objects, chemicals, liquids, vapors, fumes and the like. Many such garments are worn overtop of street clothes or work garments, for example, one-piece chemical and/or biological protective garments with connectable hood and/or face shield, gloves, booties, etc. Protective garments worn over the outermost layer make the wearer noticeable to an observer.

For secret service, military, FBI, or other government and/or undercover personnel, it may be desirable to wear a chemical and/or biological protective garment that fits under street clothes and/or a jacket such that it is undetectable to an observer. The protective garment may be worn as a precautionary measure and additional pieces such as a hood and/or face shield, breathing apparatus, and/or gloves may be donned quickly if needed.

### SUMMARY

In one aspect, two-piece protective garments are disclosed that provide protection against chemical and/or biochemical hazards. The protective garments include a top part having a body portion and sleeves, the body portion having a vapor skirt that is self-tightenable towards the torso of a wearer, and a bottom part having a fold-over waistband extension, a waistband, a seat portion, and left and right leg portions, the fold-over waistband extension being foldable over the waistband to reveal a backside of the fold-over waistband extension when the bottom part is worn by the wearer. When the top and bottom parts are worn by the wearer, the vapor skirt is positioned against the backside of the fold-over waistband and is self-tightened thereagainst as a seal that is generally impermeable to gases. In one embodiment, the backside of the fold-over waistband includes a non-slip and/or grippable surface, coating, or material to enhance the seal between the vapor skirt and the fold-over waistband extension.

The protective garment may be a multi-purpose protective garment that may be worn in a variety of configurations. In one embodiment, the top part and bottom part are wearable between the undergarments of a wearer and a layer of clothes of the wearer with the layer of clothes fully covering the top and bottom parts of the protective garment such that they are undetectable by an observer. In another embodiment, the top and bottom parts are wearable over a layer of clothing of the wearer. In another embodiment, the top and bottom parts are integrally formed into other clothing such that when the clothing is worn the top and bottom part are undetectable by an observer. In yet another embodiment, at least one of the top and bottom parts is a releasably couplable liner couplable to an outer garment.

The protective garments may include a variety of other features such as a hood that may be stowable, a tail, a vapor resistant fly, integral foot coverings, and combinations thereof.

### BRIEF DESCRIPTION OF THE DRAWINGS

FIG. 1 is a front view of a two-piece protective garment.

FIG. 2 is a front view of the two-piece protective garment of FIG. 1 with the two pieces interconnected to provide a vapor resistant barrier where the jacket meets the trousers.

FIG. 3 is a side view of an interconnected two-piece protective garment showing a jacket having a tail flap that is connectable to the trousers.

FIG. 4 is a front view of a jacket having a hood stowed within a collar of the jacket.

FIG. 5 is a side cross-sectional view of part of the coat of FIG. 1, illustrating one manner in which the elastic material is included in the vapor skirt.

FIG. 6 is a side cross-sectional view of part of the coat of FIG. 1, illustrating another manner in which the elastic material is included in the vapor skirt.

FIG. 7 is a sectional view taken through the torso of the wearer when wearing the top and bottom parts of the protective garment taken along line 4-4 of FIG. 2.

FIG. 8 is an exploded perspective view of an embodiment of a garment illustrated as a coat (outer garment), in which the top part of the protective garment of FIG. 1 is shown as a liner separated from the outer garment.

### DETAILED DESCRIPTION

The following detailed description will illustrate the general principles of the invention, examples of which are additionally illustrated in the accompanying drawings. In the drawings, like reference numbers indicate identical or functionally similar elements.

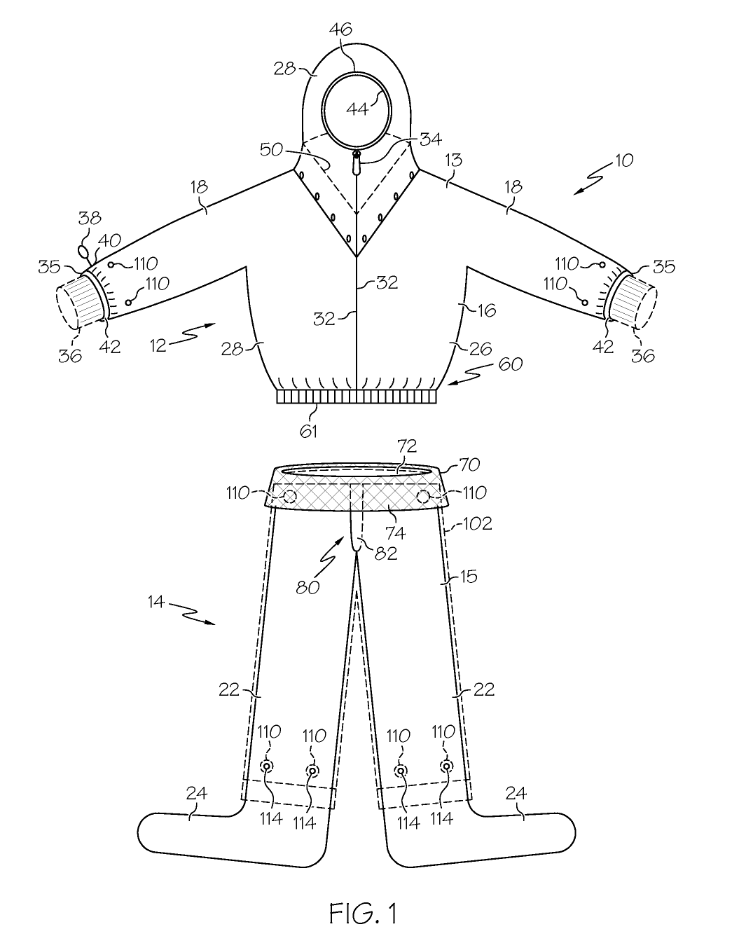

Protective garments, preferably a multi-purpose two-piece garment, generally identified as garment 10 in FIG. 1, are provided that are made from a chemical and/or biochemical resistant material that is lightweight such that the garments may be worn directly over a wearer's underclothes, worn as a middle layer between a first and second layer of clothes, or may be incorporated in an outer layer of clothing as a liner. The protective garments 10 are constructed such that they are coverable by at least one layer of clothes to render the protective garments generally undetectable to an observer. For example, the cuffs, hood, etc. do not protrude from under a shirt or jacket being worn. Accordingly, secret service, military, FBI, or other government and/or other undercover personnel can wear the protective garment 10 under street clothes and/or a jacket such that the garment 10 is not visible to an observer. When worn over or between other layers of clothing, the garment is constructed to be slightly oversized to allow freedom of movement for the wearer, yet the material is lightweight such that the oversized construction does make the clothing of the wearer look bulky.

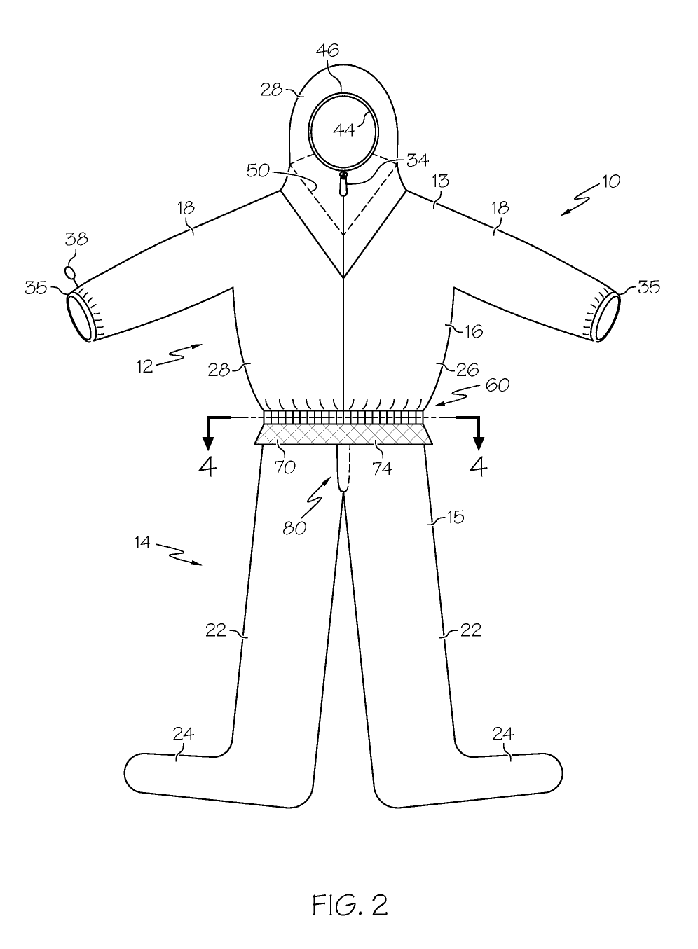

Referring to FIGS. 1-2, protective garment 10 is shown as a two-piece garment having a top part 12 configured to cover the torso and arms of a wearer and optionally the head of the wearer and a bottom part 14 configured to cover the legs and feet of a wearer. The top part 12 may include a body portion 16 configured to cover the torso of a wearer, a pair of sleeves 18 configured to cover the arms of a wearer, and a hood or head portion 20 configured to cover the head of a wearer. The top part 12 may be, but is not limited to, a jacket, coat, shirt, or pull-over garment. The sleeves 18 may be detachably, sealingly connectable to gloves (not shown). The bottom part 14 may include a pair of legs 22 configured to cover the legs of a wearer and integrally connected foot coverings 24.

The chemical and/or biochemical resistant material for construction of the garment 10 desirably prevents or reduces the introduction of harmful substances or chemicals into the garment. Such harmful substances may include liquids (including chemical warfare agents, biological warfare agents and toxic industrial chemicals), vapors and aerosols (including chemical warfare agents and toxic industrial chemicals), and contaminated particulates (such as biological warfare agents). Examples of chemical warfare agents include soman (GD) nerve agent and distilled mustard (HD) blister agent. Examples of toxic industrial chemicals include acrolein (liquid), acrylonitrile (liquid), ammonia (gas), chlorine (gas), and dimethyl sulfate (liquid).

In one embodiment, the chemical and/or biochemical resistant material may be made of or include polypetrafluroethylene (PTFE) (such as GORE-TEX® or CROSSTECH® materials), polyurethane or polyurethane-based materials, neoprene or neoprene-based materials, cross-linked polymers, polyamid, or GORE® CHEMPAK® materials, sold by W.L. Gore & Associates, Inc. including GORE® CHEMPAK® Ultra Barrier Material, GORE® CHEMPAK® Selectively Permeable Material, or GORE® CHEMPAK® Sorptive Material. Besides the materials outlined above, the garment 10 can be made of nearly any material that is generally impermeable to a particular harmful material. In general, since gases typically are able to permeate many materials, if the garment 10 is able to block gases, it may similarly be able to block other undesirable materials, such as vapors or aerosols. In one embodiment, the chemical and/or biochemical resistant material is non-stretchy.

In one embodiment, the chemical and/or biochemical resistant material is preferably GORE® CHEMPAK® Ultra Barrier Material, which is a tri-laminate having a layer that is generally fluid/gas impermeable layer to form a barrier layer which provides the majority of the resistance of the garment 10 to gas influx, such as PTFE. The other layers of the tri-laminate may be made of a blend of aramid, para-aramid and carbon fibers. An outer layer may be a woven material that consists of about 95% aramid material, about 3% para-aramid material and about 2% carbon, for example, NOMEX® material sold by E.I. DuPont de Nemours and Company of Wilmington, Del., and more particularly may be NOMEX® 3A material. An inner layer may be made of knitted material (such as NOMEX®) to provide comfort to the wearer and provide protection to the intermediate layer. The outer layer, PTFE, and inner layer may all be laminated together to form a single integral sheet of material. Thus, the chemical and/or biochemical resistant material may be a chemical/biological protective fabric including a continuous fluoropolymer barrier film 34 laminated between outer and inner aramid textiles.

In one embodiment, the chemical and/or biochemical resistant material includes only two layers of material rather than being a tri-laminate. Having two layers rather than three provides a lighter weight material. The two layer material preferably includes thin, durable, high-strength layer that is generally fluid/gas impermeable to form a barrier layer which provides a majority of the chemical resistance of the garment 10. In one embodiment, the thin, durable, high strength layer is a PTFE film. The PTFE film is bonded to a layer of lightweight textiles. A lighter weight chemical and/or biochemical resistant material is preferred for protective garments 10, since the garment 10 is designed to be worn under other garments, such as street clothes, for extended periods of time.

Suitable chemical and/or biochemical resistant materials are those that meet the Chem/Bio Option of the NFPA 1971 standards (the entire contents of which are hereby incorporated by reference). The Chem/Bio Option provides specifications that protective ensembles must meet in order to be certified thereunder. For example, the garment must pass a Man In Simulant Test (“MIST”, sometimes referred to as a “shower test”), which includes introducing the garment into a chamber filled with a vaporized test material (such as oil of wintergreen), placing an absorbent padding on the wearer and/or inside the garment, and after exposure, typically about a twenty minute exposure, to the vaporized oil of wintergreen, the absorbent pads are removed and analyzed to determine how much of the vaporized test material they have absorbed. The standards for the MIST test are available as the ASTM F 1359 shower test. The protective garment 10 may provide a garment/ensemble which passes the MIST.

The two-piece protective garment 10 is closer fitting than a one-piece protective suit that is worn over the wearer's clothes or other garments as an outer layer. The two-piece protective garment 10 is constructed with the top part 12 and bottom part 14 such that they are more similar in fit to regular street clothes such that the protective garment 10 can be worn underneath other garments. In one embodiment, the protective garment 10 may have a stretchy quality that enhances the fit to the wearer thereby making the garment have a closer fit. Being two pieces and constructed for chemical and/or biochemical protection provides a unique challenge in constructing the protective garment 10 to have a air-tight, vapor-tight, and/or moisture-tight seal where the two pieces join, yet allowing the suit to be movable with the wearer. The two-piece protective garment 10, as shown in FIGS. 1-2, includes a vapor skirt 60 on the top part 12 sealably engageable or engaged with the backside 74 of a fold-over waistband extension 70. The two-piece protective garment 10 may also include a tail 90 extending from either the top part 12 or the bottom part 14 that is releasably connectable to the other part of the garment 10 to prevent the coat 13 from riding up on the back of the wearer when the wearer is moving or bending. These features will be described in more detail below.

Coat

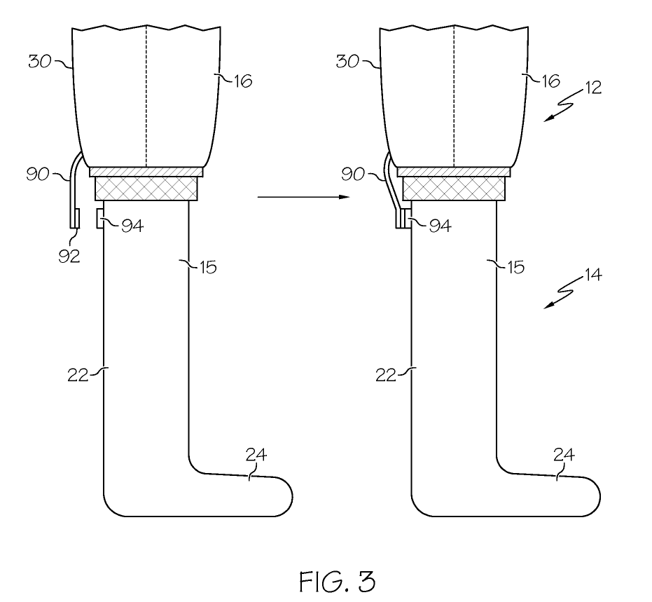

In FIGS. 1-4, top part 12 is illustrated as a coat 13 that includes a body portion 16 having a left front panel or portion 26, right front panel or portion 28, a back panel or portion 30 (FIG. 3). The panels/portions 26, 28, 30 may be made of separate pieces of material that are joined together, or can be made of a single piece of material, or various pieces of material joined in varying manners, etc. The left front panel 26 and right front panel 28 may each have an inner edge 32 that are releasably attachable together by a fastener 34, such as a zipper, snaps, clasps, clips, hook-and-loop fastening material (i.e., VELCRO® fastening material), combinations of these components or the like. The body portion 16 defines a torso portion/torso cavity that is shaped to receive a wearer's torso therein. The coat 13 may include a pair of sleeves 18 coupled to and extending generally outwardly from the body portion 16 that are shaped to receive a wearer's arms therein.

Vapor Skirt

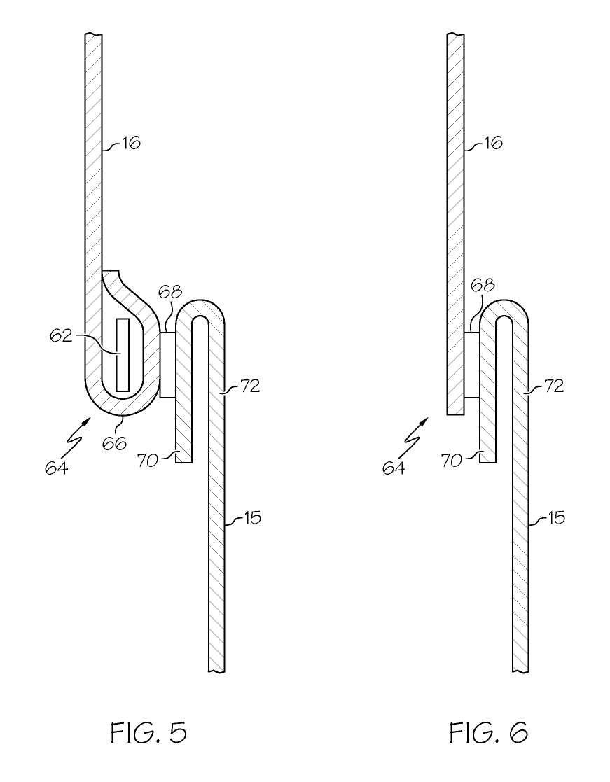

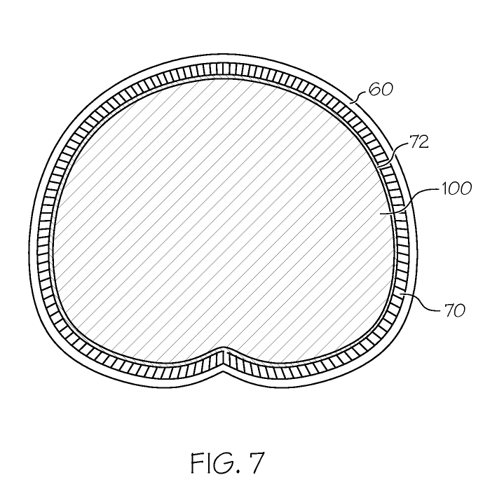

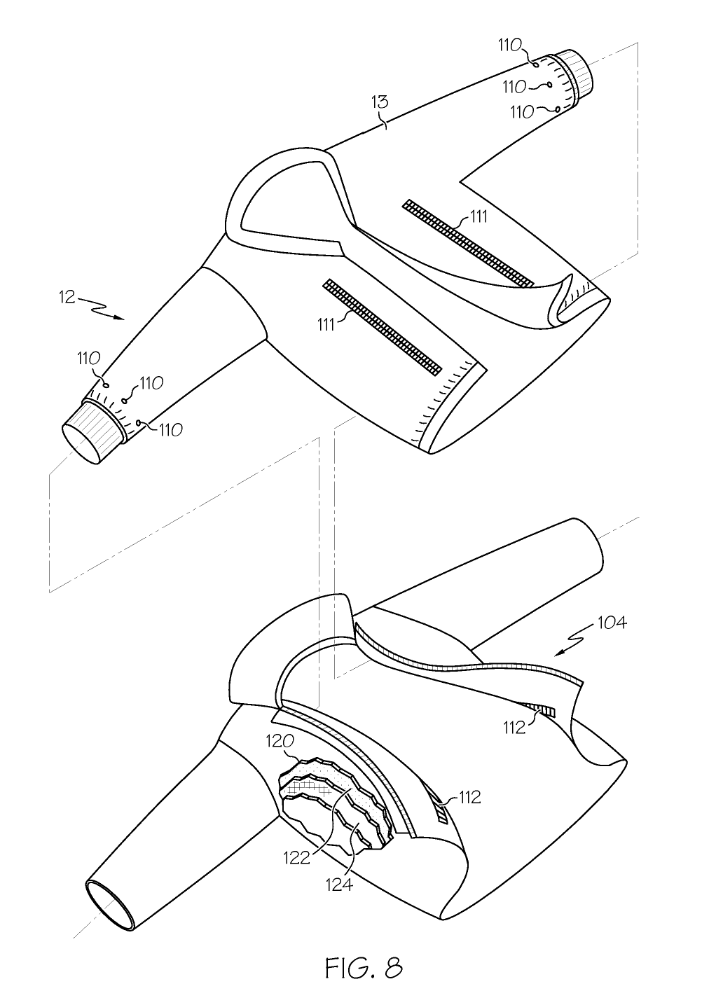

Garment 10, as shown on coat 13 of FIG. 1, includes an integral vapor skirt 60 at the bottom edge 61 of the body portion 16. The vapor skirt 60 as part of the body portion 16 is configured such that when the coat 13 is closed, the vapor skirt 60 may extend 360 degrees or more about a wearer 100, as shown in FIG. 7. The vapor skirt 60 may be self-tightenable towards the torso of the wearer. As shown in FIGS. 5-6, the vapor skirt 60 may have an elastic material 62 coupled to or forming an inner edge 64 thereof to ensure that the vapor skirt 60 contacts and generally forms a seal with the wearer 100 by engaging the fold-over waistband extension 70 for an air-tight, vapor-tight, and/or moisture-tight engagement that generally blocks harmful substances or chemical from entering the garment 10.

In particular, still referring to FIGS. 5-6, the vapor skirt 60 includes a strip of elastic material 62 positioned on or adjacent to its inner edge 64. As shown in FIG. 7, when the coat 10 is closed, the elastic material 62 is stretched such that the inner edge 64 of the vapor skirt 60 fits around, and conforms to, the torso/body of the wearer 100. Thus, in this configuration when the coat 10 is closed the vapor skirt 60 is generally “disc” shaped with a central opening that corresponds to the torso of the wearer 100.

When the coat 13 is opened (i.e. the left front panel 26 is not attached to the right front panel 28 and the panels 26, 28 are moved apart, and/or when the coat 13 is not being worn), the elastic material 62 retracts to its unstressed or un-deformed shape, thereby gathering the material of the vapor skirt 60. The elastic material 62 may stretch between about 15%-75% (about 50%, in one case) when the coat 13 moves from its open position to its closed position, and returns to its original state when the stretching forces are removed. It may be desired to configure the elastic material 62 so that when the coat 13 is closed and the vapor skirt 60 is deployed, the vapor skirt 60 is stretched smooth and flat, with little or no bunching at or adjacent to the elastic material 62 so that the vapor skirt 60 forms a good and relatively tight seal with the wearer. If there is too much elastic material 62 (or the elastic material 62 is too strongly elastic), then the vapor skirt 60 will not be pulled tight and will remained bunched up at or adjacent to the elastic material 62 when the vapor skirt 60 is employed. Conversely, if there is not enough elastic material 62 (or the elastic material 62 is too weakly elastic) the vapor skirt 60 may not be about to be stretched about a wearer. Accordingly, the amount and strength of the elastic material 62 may be selected to ensure a proper seal is formed with wearers of a variety of sizes and shapes.

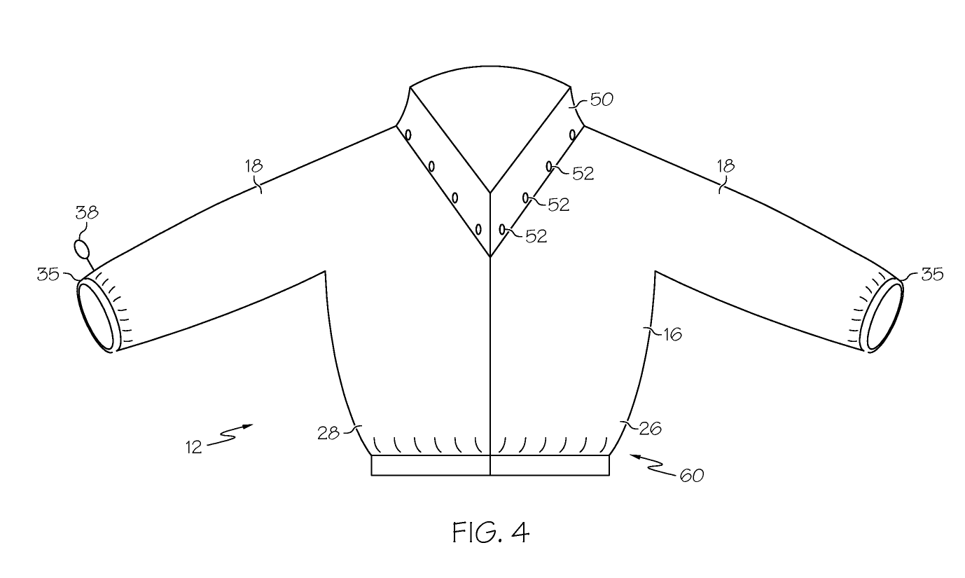

In the embodiment of FIG. 5, the material of the vapor skirt 60 forms or is formed into a closed loop 66 at its inner edge 64, and the elastic material 62 is positioned in, or captured in, the loop 66. This configuration protects the elastic material 62, and allows the material of the vapor skirt 60 (and the loop 66) to slide freely relative to the elastic material 62 as the elastic material 62 is stretched and retracts. In this embodiment, a gripping material 68 (such as rubber, synthetic rubber, or the like) may be coupled to the radially inner edge 64 of loop 66. The gripping material 68 helps to ensure that the inner edge 64 of the loop 66 frictionally engages the backside 74 of the fold-over waistband extension 70 to ensure a relatively tight seal therewith, as shown in FIGS. 2 and 4.

FIG. 6 illustrates an alternate embodiment wherein the vapor skirt 60 lacks the closed loop 66. In this embodiment the elastic material 62 is directly attached to the inner edge 64 of the vapor skirt 60, such as by stitching, adhesives or the like. In this embodiment, the elastic material 62 may act as a gripping surface which frictionally grips the backside 74 of the fold-over waistband extension 70, and a separate gripping surface or material 68 may not be needed.

The seal formed by the vapor skirt 60 can help prevent the introduction of harmful materials into the torso cavity of the protective garment 10. Such harmful materials may include liquids (including chemical warfare agents, biological warfare agents and toxic industrial chemicals), vapors and aerosols (including chemical warfare agents and toxic industrial chemicals), and contaminated particulates (such as biological warfare agents). Examples of chemical warfare agents include soman (GD) nerve agent and distilled mustard (HD) blister agent. Examples of toxic industrial chemicals include acrolein (liquid), acrylonitrile (liquid), ammonia (gas), chlorine (gas), and dimethyl sulfate (liquid). However, it should be understood that the vapor skirt 60 can be utilized to prevent or minimize the introduction of nearly any desired material, gas, fluid, liquid, particulate solids, etc. into the protective garment 10, including smoke, water vapor, liquid water, etc.

Cuffs

The coat 13, as shown in FIGS. 1-2, includes sleeves 18 that each terminate in cuffs 35. Cuffs 35 may be releasably cinchable to the wrists of the wearer to provide a secure air-tight, vapor-tight, and/or moisture-tight seal. In one embodiment, cuffs 35 may include a drawstring 38 for cinching the cuffs 35 to the wearer's wrist. The drawstring 38 may include a releasably locking fastener 40 to hold the drawstring in the cinched position. In another embodiment, cuffs 35 may include a second elastic material 42 coupled to or forming the terminal edge of the sleeves 18 that contacts and generally forms a seal with the wrists of the wearer. The second elastic material 42 may be a strip of such material positioned on or adjacent the terminal edge of the sleeves 18. When the coat 13 is donned, the second elastic material 42 of each cuff 35 is stretched such that the terminal edge of the sleeve fits around, and conforms to, the wrists of the wearer. The second elastic material 42 may be incorporated in the sleeves 18 similarly to the elastic material 62 for the vapor skirt 60 at the bottom edge 61 of coat 13. The second elastic material 42 may be the same or different from the elastic material 62 of the vapor skirt. It is understood that other means of cinching the cuffs 35 to a wearer's wrists are possible, for example, a strip of hook and loop fastener or a strap with a fastener.

In one embodiment, as shown in FIG. 1, each sleeve 18 of coat 13 may include cuffs 35 that are finished with knit wristlets 36 that are stretchable for a sealingly connectable fit to the wrist of the wearer. In one embodiment, the knit wristlets may be made of or include aramid material.

In another embodiment, the cuffs 35 and/or the sleeves 18 may include releasable attachment members for connecting gloves (not shown) to the coat 13. The gloves may cover the hands and wrists of a wearer and provide chemical/biochemical protection.

Hood

Still referring to FIGS. 1-2, coat 13 includes hood 20 connected to the body portion 16 that may be deployable. Hood 20 may be integral or removeably attachable to the body portion 16. The hood may be of the same material as rest of the coat 13 or may be different. Suitable materials are described above that can provide the desired chemical and/or biochemical resistance. When not deployed, hood 20 may be stored in the coat 13, for example, in the collar 50 (see FIG. 4) or may lay between the coat 13 and a garment worn over top thereof such that the hood is hidden and unnoticeable by an observer.

In one embodiment, as shown in FIG. 4, the hood 20 is integral with the body portion 16 and is stowed in the collar 50. Hood 20 may be rolled toward the body portion 16 and the collar 50 folds over the hood 20 and fastens to the body portion 16 to hold the hood 20 in the stowed position. Thus, the collar 50 includes releasable attachment members 52. When the hood 20 is deployed, the hood may surround a portion or the entire collar 50 and, in this case, collar 50 may be obscured by the hood. In this case, collar 50 need not provide any specific protection to the wearer and may be made of any appropriate material, preferably a material that is comfortable to the wearer. Such materials include, for example, natural and synthetic fibers.

In one embodiment, the hood 20 may be removeably attachable to the body portion 16 and when disconnected therefrom may be stowed in an accessible receptacle to the wearer. In one embodiment, the receptacle may be a pocket on the body portion or any other garment worn by the wearer. The hood 20 may include a releasable attachment member (not shown) that may be the same as or different from the other releasable attachment members used on other aspects of the garment 10. The body portion 16 proximate the neck includes a mating releasable attachment member (not shown) that may be the same as or different from the other releasable attachment members used on other aspects of the garment 10 for mating with the releasable attachment member on the hood 20. However, to maintain the protective quality of the garment 10, the hood 20 and the body portion 16 need to provide a air-tight, vapor-tight, and/or moisture-tight barrier. In one embodiment, the releasable attachment member and the mating releasable attachment member may be a zipper such as a vapor resistant zipper.

The zipper is preferably an air-tight, vapor-tight, and/or moisture-tight closure when closed, i.e., the connecting mechanism itself as its two sides are mated together form vapor-tight, and/or moisture-tight connections with one another. In one embodiment, the zipper includes interlocking teeth, “press-to-close” strips (i.e., a seal analogous to those on ZIPLOC® plastic bags), or slide-to-close strips (similar to those in U.S. Pat. No. 6,014,795, which is incorporated herein by reference in its entirety). The zipper may be a watertight zipper, such as those commercially available from YKK Corporation under the trademarks Aquaseal® and Aquaguard® and/or described in YKK Corporation's U.S. Pat. No. 7,591,051, No. 7,500,291, and No. 7,337,506, which are incorporated herein by reference in their entirety. Aquaseal® zippers are smooth and flexible and offer protection from water as a result of a film-coated tape and a zip element mechanism that seals the zipper completely. The zippers are available in various sizes and formats (such as rubber or polyurethane tape, opened-end or closed-end).

If the body portion 16 comprises a left front panel 26 and a right front panel 28 that are joinable, the fastener(s) 34 that releasably attach the two panels 26, 28 together should provide an air-tight, vapor-tight, and/or moisture-tight barrier. In one embodiment, fastener 34 is a vapor tight zipper such as those just described. The fastener 34 may extend from the body portion 16 into the hood 20. Thus, when the hood 20 is deployed, the fastener 34 may be fully closed providing protection that extends from the waist up to the face, to a level where the hood 20 can form a vapor/liquid resistant seal with a SCBA facemask and/or a respiratory hood. When the hood is not deployed, the fastener halves may not be fully connected, and when the coat is donned, may be connected or closed up to a spot just below the chin or a point where coat 13 can be fully covered by an outer garment so that coat 13 is undetectable to an observer.

Hood 20 may include a face plate opening 44 in the hood 20 with a rubber seal 46 located thereabout. The face plate opening 44 is configured to sealingly engage a face plate/mask of a wearer, such as a mask associated with a self-contained breathing apparatus (“SCBA”) or respirator. In this manner, when the garment 10 is worn, it can form a completely sealed arrangement to seal out the ambient environment of the garment.

The hood 20 in its deployed position passes the “shower test” of the Emergency Medical Garment (EMS) standard of the National Fire Protection Association (NFPA) which test requires a wearer's torso to be perfectly dry after being subjected to a shower of surfactant water from all directions during a 20 minute exposure.

Trousers

In FIG. 1, bottom part 14 is illustrated as trousers 15 having foot coverings 24 integral with the legs 22. The trousers 15 may be worn with the foot coverings 24 directly on the wearer's bare feet with socks over the foot coverings 24 or worn over a pair of socks with another pair of socks or shoes over the foot coverings 24 so that they, and hence the protective garment 10, are not visible to an observer.

Trousers 15 include a waistband 72 that fits the wearer about the waist in or about in the general position for most trousers. Extending from the waistband 72, away from the legs 22, is a fold-over waistband extension 70. The waistband extension 70 folds outwardly and downwardly over the waistband 72 to reveal a backside 74 thereof that is available for engagement with the vapor skirt 60 of the top part 12 of the protective garment 10 to provide an air-tight, vapor-tight, and/or moisture-tight barrier. The backside 74 may include a non-slip and/or grippable surface, coating, or material to enhance the seal between the top part 12 and the bottom part 14. The backside 74 may prevent or reduce the possibility of the vapor skirt 60 sliding upward, and potentially off of, the waistband extension. The backside 74 may also provide a more uniform surface for mating with the vapor skirt 60 for a better seal.

Suitable non-limiting examples of non-slip and/or grippable surfaces, coatings, or material to enhance the seal include silicone beading, elasticized silicone coated material, and/or rubbers or other similar polymers, including printed rubber or printed polymers.

The protective garment 10 with the top part 12 mated with the bottom part 14, as shown in FIGS. 2, 3, and 5-6, provides an air-tight, vapor-tight, and/or moisture-tight barrier between the vapor skirt 60 and the fold-over waistband extension 70 that passes the so-called “shower test” of the Emergency Medical Garment (EMS) standard of the National Fire Protection Association (NFPA) which test requires a wearer's torso to be perfectly dry after being subjected to a shower of surfactant water from all directions during a 20 minute exposure.

In one embodiment, the waistband extension 70 is made from or includes a stretchable material such that the waistband extension 70 may be a continuous piece of material extending about the waistband 72 of the trouser 15. In this manner, the waistband extension 70 provides an improved seal. In another embodiment, the waistband 72 and the waistband extension 70 are large enough to fit over the wearer's thighs and hips without being stretchable. The waistband 72 may be cinchable to tighten the garment 10 against the waist of the wearer. The waistband 72 may include a cinching mechanism (not shown) therein. In one embodiment, the cinching mechanism may be positioned at the center front of the waistband 72. In another embodiment, the cinching mechanism may be positioned at one or both of the left and right sides of the waistband 72. The cinching mechanism may be a gusset, drawstring, or any other mechanism that can reduce the diameter of the waistband 72 and hold the waistband 72 securely in the reduced diameter position.

As shown in FIG. 1, the bottom part 14 may be worn under another pair of trousers 102, for example a pair of dress pants, and the fold-over waistband extension 70 can be folded down over the waistband of the trousers 102. If it is desirable for the wearer to conceal the bottom part 14, they may wear a jacket, shirt, or the like that is long enough to cover the waistband extension 70. Alternately, the waistband extension 70 may be folded over the bottom part 14 itself and the trouser 102 may be worn over the waistband extension 70 and optionally a portion of the vapor skirt 60.

For another embodiment, the trousers merely have the non-slip and/or grippable surface, coating and/or material on the outer surface of a more traditional waistband against which the vapor shirt 60 will form an air-tight, vapor-tight, and/or moisture-tight barrier.

In another embodiment, the waistband extension 70 may have the non-slip and/or grippable surface, coating and/or material on both sides thereof to provide options to the wearer to leave the waistband extension 70 up instead of folding it over.

Tail

Now referring to FIG. 3, in one embodiment, the protective garment 10 may include a tail 90 extending from either the top part 12 or the bottom part 14 that is releasably connectable to the other part of the garment 10 to prevent the top part 12 and bottom part 14 from separating from one another. For example, the tail 80 can prevent the coat 13 from riding up the back of the wearer when the wearer is moving and/or bending.

The tail 90 is generally a flap of material extending, in one embodiment as shown in FIG. 3, from the coat 13 and may include a releasable attachment member 92, for example, hook-and-loop fastening material (such as VELCRO® fastening material), snaps, one or more zippers, and/or hooks to releasably couple the tail 90 to the trousers 15. Tail 90 may be a single flap or a plurality of flaps. In one embodiment, tail 90 includes two flaps that extend from the back panel 30 of the coat 13 and both include releasable attachment members 92 for connecting to a mating releasable attachment member 94. The mating releasable attachment member 94 is appropriately positioned on the trousers 15 to mate with the releasable attachment member(s) 92 on the tails 90. While tail 90 is illustrated in FIG. 3 as being fixedly attached to the coat 13 and releasably attachable to the trousers 15, it is understood that the tail 90 may be fixedly added to the trousers 15 and releasably attachable to the coat 13.

Vapor Resistant Fly

The trousers may include a vapor resistant fly 80 as illustrated in FIGS. 1-2. In one embodiment, the vapor resistant fly 80 may include a vapor resistant zipper closure (not shown) with a flap 82 of vapor resistant material that covers the zipper. The vapor resistant zipper may include a compressible body (not shown) positioned between the openable end of the zipper and an underlying piece of material to close any gap that may exist between the end of the zipper and the material to which the zipper is attached.

As shown in FIG. 1, the trousers 15 may include a vapor resistant closure 80, optionally in the traditional fly position. The vapor resistant fly 80 may be a slit within the trousers 15 that is closable with a vapor resistant closure. The slit may terminate at the waistband (i.e., the slit does not extend into or through the waistband extension 70). In another embodiment, the vapor resistant fly 80 may extend into and through the waistband extension 70 to divide the waistband extension 70 into a left panel and a right panel (not shown). This feature may make the trousers 15 easier to don and doff.

The vapor resistant closure may be a vapor resistant zipper and may include a flap 82 that covers the zipper when in the zipped position. The zipper is preferably an air-tight, vapor-tight, and/or moisture-tight closure when closed, i.e., the connecting mechanism itself as its two sides are mated together forming vapor-tight, and/or moisture-tight connections with one another. In one embodiment, the zipper includes interlocking teeth, “press-to-close” strips (i.e., a seal analogous to those on ZIPLOC® plastic bags), or slide-to-close strips (similar to those in U.S. Pat. No. 6,014,795, which is incorporated herein by reference in its entirety). The zipper may be a watertight zipper, such as those commercially available from YKK Corporation under the trademarks Aquaseal® and Aquaguard® and/or described in YKK Corporation's U.S. Pat. No. 7,591,051, No. 7,500,291, and No. 7,337,506, which are incorporated herein by reference in their entirety. Aquaseal® zippers are smooth and flexible and offer protection from water as a result of a film-coated tape and a zip element mechanism that seals the zipper completely. The zippers are available in various sizes and formats (such as rubber or polyurethane tape, opened-end or closed-end).

The compressible body becomes compressed between the zipper and the underlying material when the vapor resistant zipper is closed. As such, the compressible body provides a secure air-tight, vapor-tight, and/or moisture-tight seal. In one embodiment, the compressible body is compressed at least 10% by volume or at least 5% by volume. The compressible body may be inserted after the zipper is partially closed, so that the zipper and underlying material amount will hold the compressible body in place for compression as the zipper is further closed. In another embodiment, the compressible body is connected to the underlying material, for example, by stitching and/or an adhesive.

The compressible body may be any suitable compressible material that can be compressed tightly between the zipper and the underlying material. A material that is itself generally impermeable to gases is preferred. The compressible body may be rubber such as solid natural rubber, synthetic rubber, open or closed cell sponge or foam rubber, composite rubber, or plastic. The compressible body may be or include neoprene, natural rubber, SBR, butyl rubber, butadiene, nitrile, EPDM, ECH, polystyrene, polyethylene, polypropylene, EVA, EMA, Metallocene Resin, Polyurethane, PVC, and blends thereof.

The seal provided by the vapor resistant zipper with the compressible body may be sufficiently air-tight/vapor-tight to meet and pass the NFPA Chem/Bio Option specifications described below.

Garment as Liner

In one embodiment, the protective garment 10 may include releasable attachment members 110, 111 as shown in FIGS. 1 and 8 on the top and bottom parts 12, 14 for connecting them to or within another garment as a liner (i.e., an outer garment), for example, trousers 102 and jacket 104. While a two-piece outer garment comprising trousers 102 and a jacket 104 are shown by the combination of FIGS. 1 and 8, the outer garment is not limited thereto. In an alternate embodiment, the outer garment may be a one-piece garment. The one-piece suit may include integral gloves and booties, if desired. In one embodiment, the outer garment is a protective garment or includes a protective garment that may provide the same or different protection as the top and bottom parts 12, 14 of protective garment 10.

The releasable attachment members 110, 111 may be or include snaps, zippers, buttons, hook-and-look fastening material or the like and combinations thereof. The outer garment includes mating releasable attachment members 112 (FIG. 8) for mating with releasable attachment members 111 and another mating releasable attachment members 114 (FIG. 1) for mating with releasable attachment members 110.

Depending on the application of the outer garment, the outer garments may include various layers that provide additional protective qualities to the resulting garment, different from the chemical and/or biochemical protection provided by the protective garment 10 that is now acting as a liner. The outer garment may provide various heat, moisture, chemical, and abrasion resistant qualities so that the garments can be used as a protective, hazardous duty, and/or firefighter garment. The outer garments may include various layers, as shown in FIG. 8, such as an outer shell 120, an optional thermal liner or barrier 122 adjacent to the outer shell 120, and an inner shell 124 adjacent to the thermal barrier if present, or adjacent to the outer shell 120 if the thermal barrier is not present. The inner shell 124 is closer to the wearer of a garment than the outer shell 120 when the garment is worn.

The garment may also include an optional inner liner or inner face cloth (not shown) located inside of (closer to the wearer when worn) and adjacent to the inner shell 124. The inner face cloth, which may be the innermost layer, can provide a comfortable surface for the wearer and protect the inner shell 124 and/or thermal liner from abrasion and wear. It should be understood that any number of layers, liners, and the like may be included and may be layered in various arrangements as desired, in which the various layers described herein are included, omitted, and/or rearranged.

The outer shell 120 may be made of or include a variety of materials, including a flame, heat and abrasion resistant material such as a compact weave of aramid fibers and/or polybenzamidazole fibers. Commercially available aramid materials include NOMEX® and KEVLAR® fibers (both trademarks of E.I. DuPont de Nemours & Co., Inc. of Wilmington, Del.), and commercially available polybenzamidazole fibers include PBI fibers (a trademark of PBI Performance Materials of Charlotte, N.C.). Thus, the outer shell 120 may be an aramid material, a blend of aramid materials, a polybenzamidazole material, a blend of aramid and polybenzamidazole materials, or other appropriate materials. If desired, the outer shell 120 may be coated with a polymer, such as a durable, water repellent finish (i.e. a perfluorohydrocarbon finish, such as TEFLON® finish sold by E. I. Du Pont de Nemours and Company of Wilmington, Del.). The materials of the outer shell 120 may have a weight of, for example, between about five and about ten oz/yd².

The thermal liner 122 and/or inner shell 124 may be generally coextensive with the outer shell 120, or spaced slightly inwardly from the outer edges of the outer shell 120 (i.e., spaced slightly inwardly from the upper ends of the waist and from the lower edge of the garment) to provide moisture and thermal protection throughout the garment. The optional thermal liner 122 may be made of nearly any suitable material that provides sufficient thermal insulation. In one embodiment, the thermal liner 122 may constitute or include a relatively thick (i.e. between about 1/16″- 3/16″) batting, felt or needled non-woven bulk or batting material. The bulk material can also take the form of one or two (or more) layers of E-89® spunlace material made of a combination of NOMEX® and KEVLAR® material. The bulk material can also, or instead, include aramid fiber batting (such as NOMEX® batting), aramid needlepunch material, an aramid non-woven material, an aramid blend needlepunch material, an aramid blend batting material, an aramid blend non-woven material, foam (either open cell or closed cell), or other suitably thermally insulating materials. The bulk material may trap air and possess sufficient loft to provide thermal resistance to the garment. In one embodiment, the thermal liner 122 may have a thermal protective performance (“TPP”) of at least about twenty, and in another embodiment, at least about thirty-five. Moreover, in one embodiment, the garment as a whole has a TPP of at least about twenty, and in another embodiment has a TPP of at least about thirty-five.

The inner shell 124 may be a gas barrier, vapor barrier, and/or moisture barrier. In one embodiment, the inner shell 124 may include a semi-permeable (selectively permeable) or impermeable membrane material. The selectively permeable membrane material may be generally water vapor permeable but generally impermeable to liquid moisture. The membrane material may be made of or include expanded polytetrafluoroethylene (“PTFE”) such as GORE-TEX or CROSSTECH materials (both of which are trademarks of W.L. Gore & Associates, Inc. of Newark, Del.), polyurethane-based materials, neoprene-based materials, cross-linked polymers, polyamid, GORE® CHEMPAK® materials, sold by W.L. Gore & Associates, Inc. including GORE® CHEMPAK® Ultra Barrier Material, GORE® CHEMPAK® Selectively Permeable Material, or GORE® CHEMPAK® Sorptive Material, or other materials.

The semi-permeable membrane material may have microscopic openings that permit moisture vapor (such as water vapor) to pass therethrough, but block liquids (such as liquid water) from passing therethrough. The semi-permeable membrane material may be made of a microporous material that is either hydrophilic, hydrophobic, or somewhere in between. The semi-permeable membrane material may also be monolithic and may allow moisture vapor transmission therethrough by molecular diffusion. The semi-permeable membrane material may also be a combination of microporous and monolithic materials (known as a bicomponent moisture barrier), in which the microporous or monolithic materials are layered or intertwined.

In one embodiment, the semi-permeable membrane material, optionally, may be bonded, adhered or otherwise attached to a substrate (not shown). The substrate may be a flame and heat resistant material that provides structure and protection to the semi-permeable membrane material. The substrate may be or include aramid fibers similar to the aramid fibers of the outer shell 120, but may be thinner and lighter in weight. The substrate may be woven, non-woven, spunlace or other materials. If desired, and in certain embodiments, the inner shell 124 may lack a substrate, or may include a substrate on both sides of the semi-permeable membrane material.

The outer garment or the garment as a whole (i.e., outer garment with protective garment 10 as a liner), may meet the National Fire Protection Association (“NFPA”) 1971 standards for protective firefighting garments (“Protective Clothing for Structural Firefighting”), which are entirely incorporated by reference herein. The NFPA standards specify various minimum requirements for heat/flame resistance and tear strength. For example, in order to meet the NFPA standards, the garment must be able to resist igniting, burning, melting, dripping, separation and/or shrinking by more than 10% in any direction at a temperature of 500° F. for at least five minutes. Furthermore, in order to meet the NFPA standards, the combined layers of the garment must provide a thermal protective performance rating of at least thirty-five.

Although the invention is shown and described with respect to certain embodiments, it should be clear that modifications will occur to those skilled in the art upon reading and understanding the specification, and the present invention includes all such modifications.

What is claimed is:

1. A chemical and/or biochemical resistant protective garment comprising:
a top part including a body portion and sleeves, the body portion having a vapor skirt that is tightenable towards the torso of a wearer;
a bottom part including a fold-over waistband extension, a waistband, a seat portion, and left and right leg portions, the fold-over waistband extension being foldable over the waistband to reveal a backside of the fold-over waistband extension when the bottom part is worn by the wearer;
wherein, when the top and bottom parts are worn by the wearer, the vapor skirt is positioned against the backside of the fold-over waistband and is tightened thereagainst as a seal that is generally impermeable to gases.

2. The protective garment of claim 1 wherein the backside of the fold-over waistband includes at least one of a non-slip or grippable surface, coating, or material to enhance the seal between the vapor skirt and the fold-over waistband extension.

3. The protective garment of claim 1 wherein the vapor skirt is self-tightenable towards the torso of the wearer.

4. The protective garment of claim 1 wherein the top part and bottom part are made of or include a two-layer chemical and/or biochemical resistant material.

5. The protective garment of claim 1 wherein the top part and bottom part are wearable between the undergarments of a wearer and a layer of clothes of the wearer.

6. The protective garment of claim 5 wherein the top part and bottom part are fully covered by the clothes of the wearer such that the top and bottom parts are undetectable by an observer.

7. The protective garment of claim 1 wherein the top and bottom parts are wearable over a layer of clothing of the wearer.

8. The protective garment of claim 1 wherein the top and bottom parts are integrally formed into other clothing such that when the clothing is worn the top and bottom part are undetectable by an observer.

9. The protective garment of claim 1 wherein at least one of the top and bottom parts is a releasably couplable liner couplable to an outer garment.

10. The protective garment of claim 1 wherein the top part further comprises a hood that is stowable, such that the hood is undetectable to an observer when the top part is worn by a wearer with the hood stowed.

11. The protective garment of claim 1 wherein the top part includes a tail extending from the body portion, the tail including a releasably attachment member connectable to a mating releasable attachment member positioned on the bottom part for mating engagement with the releasable member of the tail.

12. The protective garment of claim 11 wherein the mating releasable attachment member is on the seat portion of the bottom part.

13. The protective garment of claim 1 wherein the bottom part includes a tail extending from the seat portion thereof, the tail including a releasable attachment member connectable to a mating releasable attachment member positioned on the top part for mating engagement with the releasable attachment member of the tail.

14. The protective garment of claim 13 wherein the bottom part includes a left foot covering integral with the left leg portion and a right foot covering integral with the right leg portion.

15. The protective garment of claim 13 wherein the bottom part includes a vapor resistant fly comprising a watertight zipper that is generally impermeable to gases.

16. The protective garment of claim 15 wherein the top and bottom parts when worn by a wearer and the vapor resistant fly are each generally impermeable to fluids, gases, vapors, aerosols and particulates.

17. The protective garment of claim 1 wherein the top and bottom parts conform with the NFPA Chem/Bio Option of the NFPA 1971 standards.

18. The protective garment of claim 1 wherein the seal between the vapor skirt and the fold-over waistband passes a twenty minute shower test.

19. The protective garment of claim 1 wherein each sleeve of the top part terminates in a cuff that is releasably cinchable to the wrist of the wearer.

20. The protective garment of claim 19 wherein each cuff includes a knit wristlet.
